(19) United States
(12) Patent Application Publication
(10) Pub. No.: US 2015/0333424 A1
(43) Pub. Date: Nov. 19, 2015

(54) ELECTRICAL CONNECTORS AND METHODS OF MAKING SAME

(71) Applicant: 3M INNOVATIVE PROPERTIES COMPANY, Saint Paul, MN (US)

(72) Inventors: Cheryl L. S. Elsbernd, Woodbury, MN (US); Ranjith Divigalpitiya, Ontario (CA); Gary A. Korba, Woodbury, MN (US)

(21) Appl. No.: 14/653,874

(22) PCT Filed: Dec. 12, 2013
(86) PCT No.: PCT/US2013/074527

§ 371 Date: Jun. 19, 2015

Related U.S. Application Data
(60) Provisional application No. 61/740,143, filed on Dec. 20, 2012.

(51) Int. Cl. H01R 13/03

(52) U.S. Cl. CPC H01R 13/03

(57) ABSTRACT

An electrical connector includes a contact for making electrical connection with a corresponding contact of a mating connector. The electrical connector further includes a carbon layer disposed on a contact surface of the contact. The carbon layer has a morphology comprising graphite platelets embedded in nano-crystalline carbon.

### CROSS REFERENCE TO RELATED APPLICATIONS

This application claims the benefit of U.S. Provisional Application No. 61/740,143, filed Dec. 20, 2012, the disclosure of which is incorporated by reference herein in its entirety.

### FIELD

The present disclosure relates to electrically conducting members bearing carbon layers thereon, and methods of making same.

### SUMMARY

In some embodiments, an electrical connector is provided. The electrical connector includes a contact for making electrical connection with a corresponding contact of a mating connector. The electrical connector further includes a carbon layer disposed on a contact surface of the contact. The carbon layer has a morphology comprising graphite platelets embedded in nano-crystalline carbon.

In some embodiments, a method of making an electrical connector is provided. The method includes providing a contact for making electrical connection with a corresponding contact of a mating connector. The method further includes applying a dry composition comprising a carbon material on or over a contact surface of the contact.

In some embodiments, an article is provided. The article includes an elongated flexible conductor. The flexible conductor includes an exterior surface. The article further includes a carbon layer disposed on the exterior surface. The carbon layer has a morphology that includes graphite platelets embedded in nano-crystalline carbon.

In some embodiments, an electrical connector is provided. The electrical connector includes an insulative housing and a plurality of contacts for making electrical connection with corresponding contacts of a mating connector. The contacts include a contact surface. The contacts are at least partially disposed within the insulative housing. The electrical connector further includes a carbon layer disposed on the contact surfaces. The carbon layer has a morphology including graphite platelets embedded in nano-crystalline carbon.

The above summary of the present disclosure is not intended to describe each embodiment of the present invention. The details of one or more embodiments of the disclosure are also set forth in the description below. Other features, objects, and advantages of the invention will be apparent from the description and from the claims.

### BRIEF DESCRIPTION OF THE DRAWINGS

The disclosure may be more completely understood in consideration of the following detailed description of various embodiments of the disclosure in connection with the accompanying figures, in which:

FIGS. 1A-1B illustrate schematic side views of an electrical connector device in an uncoupled and coupled state, respectively;

FIG. 2 is a scanning tunneling microscope image of a carbon layer formed in accordance with some embodiments of the present disclosure;

FIG. 3 shows resistance measurements of Example 1 and Comparative Example A samples mated with gold-plated contacts after 1, 5, and 25 mating cycles;

FIG. 4 shows resistance measurements of thermal-shocked and temperature-humidity cycled samples of Example 1 and Comparative Example A mated with gold-plated contacts after 1, 5, and 25 mating cycles;

FIG. 5 is a photomicrograph of an Example 3 connector sample after 25 mating cycles with gold-coated contacts;

FIG. 6 shows ESCA data for “as prepared” areas of coatings for the Example 3 sample shown in FIG. 5; and

FIG. 7 shows ESCA data for “worn” areas of coatings for the Example 3 sample shown in FIG. 5.

### DETAILED DESCRIPTION

Electrical connector devices are typically formed of one or more electrically conducting metal contacts that operate to connect electrical components. For example, such devices often include corresponding contact surfaces of a post-type design that, when interconnected, conduct electrical current between mating electrically conducting contacts of the device. To ensure proper functioning of the connector device, electrical conduction from one contact of the interconnect to the mating contact of the connector should be reliably achieved and dependably maintained.

A significant cause of electrical contact failure arises from corrosion, oxidation, and/or contaminant formation on the surfaces of a metal connector. Since gold is an excellent electrical conductor, and is corrosion and oxidation resistant, contact surfaces of connectors are often coated with gold to mitigate conductivity failures. Gold, however, is expensive, and it is soft and therefore wears away relatively quickly on contacts that are subjected to friction forces. Consequently, a low cost alternative to gold, which exhibits durability and provides similar electrical conductivity and corrosion resistance to that of gold may be desirable.

### DEFINITIONS

As used herein, “carbon nanolayer” refers to a layer of carbonaceous material having an average thickness of less than about 1000 nanometers.

As used herein, “exfoliatable material” refers to materials (e.g., particles) that break up into flakes, scales, sheets, or layers upon application of shear force.

As used herein, “graphite platelet” refers to a graphitic carbon material having a first order laser Raman spectrum that exhibits two absorption bands including a sharp, intense band (G peak) centered at about 1570-1580 cm⁻¹, and a broader, weak band (D peak) centered at about 1320-1360 cm⁻¹.

As used herein, “nano-crystalline carbon” refers to a carbon material having a first order laser Raman spectrum that exhibits two absorption bands including a pair of weak bands (G peaks) centered at about 1591 cm⁻¹ and 1619 cm⁻¹, respectively, and a sharp, intense band (D peak) centered at about 1320-1360 cm⁻¹.

As used herein, the singular forms “a”, “an”, and “the” include plural referents unless the content clearly dictates otherwise. As used in this specification and the appended embodiments, the term “or” is generally employed in its sense including “and/or” unless the content clearly dictates otherwise.

As used herein, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

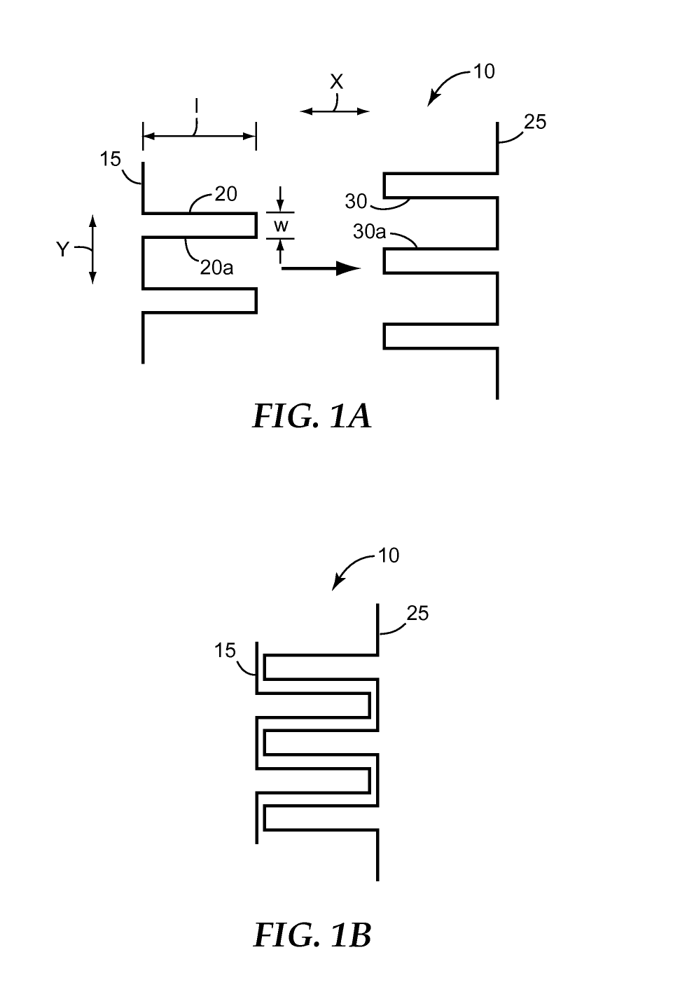

In some embodiments, the present disclosure relates to electrical connector devices having one or more components (e.g., contacts) bearing thereon at least one carbon layer. Generally, an electrical connector device may refer to any device having one or more electrically conducting contacts and one or more complementary/mating electrically conducting contacts, which are configured to couple with one another such that electrical current may be conducted between the contacts. FIGS. 1A and 1B illustrate schematic side views of an example of an electrical connector device 10 in an uncoupled and coupled state, respectively. As shown, the electrical connector device 10 may include a first connector 15 having one or more electrically conducting contacts 20, and a second connector 25 having one or more mating electrically conducting contacts 30. While FIGS. 1A-1B illustrate a certain number of electrically conducting contacts 20, 30, it is to be appreciated that any number of electrically conducting contacts 20, 30 (more or less than that depicted in FIGS. 1A-1B) may be provided. The electrically conducting contacts 20 may include a contact surface 20a, which is configured to couple with a complementary/mating contact surface 30a of the mating electrically conducting contacts 30. As will be appreciated by those skilled in the art, one of the first connector 15 and the second connector 25 may be coupled to a electrical current source (e.g., via a cable) and the other of the first connector 15 and the second connector 25 may be coupled to a device configured to receive electrical current from the electrical current source. As will further be appreciated by those skilled in the art, the electrical connector device 10 may include an insulative housing within which the electrically conducting contacts 20 or 30 may at least partially be disposed.

As shown in FIGS. 1A-1B, the electrically conducting contacts 20, 30 may be formed as generally rectangular structures having substantially smooth, planar contact surfaces 20a, 30a. It should be noted, however, that the electrically conducting contacts 20, 30 need not have the shape or configuration shown in FIGS. 1A-1B. Rather, the electrically conducting contacts 20, 30 can have a variety of shapes (including three-dimensional or cross-sectional shapes), including but not limited to, cylindrical, pyramidal, triangular, and hook-shaped, parallelepipedal, spherical, hemi-spherical, polygonal, conical, frusto-conical, other suitable shapes, and combinations thereof. Moreover, the contact surfaces 20a, 30a may be provided with any degree of surface roughness suitable for a particular application. Furthermore, the contact surfaces 20a, 30a need not be precisely planar in configuration (although they may be if desired), but can be curved, rounded, bent, or of any other non-planar shape as desired for a particular application.

In some embodiments, the electrically conducting contacts 20, 30 may be formed, entirely or in part, from an electrically conducting material. For example, the electrically conducting material may include a metal, polymer, or other known conducting material. Suitable metals include, for example, copper, aluminum, nickel, platinum, tin, indium, combinations thereof, or alloys thereof.

Referring again to FIGS. 1A-1B, generally, each electrically conducting contacts 20, 30 may include a x-dimension, or length l, that generally extends along an x-direction, a y-dimension, or width w, that generally extends along an y-direction oriented substantially orthogonally to the x-dimension, and a z-dimension, or height h (not shown), that generally extends along a z-direction (not shown) oriented substantially orthogonally to the y-dimension. Generally, the height, length, and width of the electrically conducting contacts 20, 30 may be of any desired magnitude and may be selected to accommodate any particular application. The height, length, and width of the electrically conducting contacts 20, 30 may be the same throughout the device 10, or may vary throughout the device. In some embodiments, the average length of the electrically conducting contacts 20, 30 may be at least 3 millimeters (mm), at least 10 mm, or even at least 30 mm; the average length of the electrically conducting contacts 20, 30 may be no greater than 75 mm, no greater than 30 mm, or even no greater than 10 mm; the average height of the electrically conducting contacts 20, 30 may be at least 0.1 mm, at least 1 mm, or even at least 3 mm; the average height of the electrically conducting contacts 20, 30 may be no greater than 5 mm, no greater than 3 mm, or even no greater than 1 mm, the average width of the electrically conducting contacts 20, 30 may be at least 0.1 mm, at least 3 mm, or even at least 5 mm; and the average width of the electrically conducting contacts 20, 30 may be no greater than 10 mm, no greater than 5 mm, or even no greater than 1 mm.

In various embodiments, the electrically conducting contacts 20 may be completely received by the mating electrically conducting contacts 30 (or vice versa). That is, the entirety of the contact surface 20a may mate with the contact surface 30a. Alternatively, the electrically conducting contacts 20 may be only partially received by the mating electrically conducting contacts 30 (or vice versa). That is, less than the entirety of the contact surface 20a may mate with the contact surface 30a.

As previously discussed, in some embodiments, one or more of the electrically conducting contacts 20 may include a contact surface 20a on or over which a carbon layer may be formed. Similarly, one or more of the electrically conducting contacts 30 may include a contact surface 30a on or over which a carbon layer may be formed. In various embodiments, a carbon layer may be formed on or over the contact surfaces of both the electrically conducting contacts 20 and the electrically conducting contacts 30. Alternatively, a carbon layer may be formed on or over the contact surfaces of only one of the electrically conducting contacts 20 and the electrically conducting contacts 30. The carbon layers may be provided on any portion of the contact surfaces 20a, 30a up to the entirety of the contact surfaces 20a, 30a. For example, the carbon layer may be provided on all (or substantially all) of the exposed surfaces of the contacts 20, 30. By covering all exposed surfaces of the contacts 20, 30, the carbon layer may facilitate protection of the contacts 20, 30, from oxidation and/or corrosion.

In various embodiments, the carbon layers may be deposited directly onto the contact surfaces 20a, 30a (i.e., a bare surface). Alternatively, the carbon layers may be deposited over one or more intermediate layers disposed on the contact surfaces 20a, 30a. For example, one or more polymer layers, mono layers, and/or metal plating layers may be arranged between the contact surfaces 20a, 30a and the carbon layers.

In some embodiments, the carbon layer may be formed from or include any form or type of elemental carbon Exemplary carbons useful in the carbon layer include conductive carbons such as graphite, carbon black, lamp black, or other conductive carbon materials known to those of skill in the art. In various embodiments, exfoliatable carbon particles may be used to form the carbon layer. Suitable exfoliatable carbon particles include HSAG300 graphite particles, available from Timcal Graphite and Carbon, Bodio, Switzerland. Other useful materials include but are not limited to SUPER P and ENSACO (Timcal), M850 available from Asbury Carbon, Asbury, N.J., and xGnP-M-25 available from XGSciences, Lansing, Mich. The carbon particles may also include carbon nanotubes, including multi-walled carbon nanotubes. In some embodiments, the carbon particles used to form the carbon layer may have a Mohs' hardness between 0.4 and 3.0, and may have a largest dimension of less than about 100 microns. In some embodiments, the carbon layer may include additional components such as polymeric microspheres and/or other microspheres.

As will be discussed in greater detail below, in various embodiments, the carbon layer may be formed on the contact surfaces by application of a dry composition that includes carbon particles. For purposes of the present disclosure, “dry” means free or substantially free of liquid. Thus, the dry composition which forms the carbon layer may be provided in a solid particulate form, rather than in a liquid or paste form.

In some embodiments, the carbon layer may further include a binder. The binder can function to improve adhesion of the components of the carbon layer, as well as adhesion of the layer to the electrically conducting contacts 20, 30. Exemplary polymeric binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Other exemplary binders include acrylic polymers, oligomers, and copolymers. Specific examples of polymer binders include polymers or copolymers of vinylidene fluoride, tetrafluoroethylene, and propylene; and copolymers of vinylidene fluoride and hexafluoropropylene. An exemplary binder that can be useful includes KYNAR 741 (polyvinylidene fluoride), available from Arkema, Oakville, Canada. The binder may be present in the carbon layer in an amount of at least 10, at least 25, at least 50, or even at least 75 weight percent based on the total weight of the carbon layer.

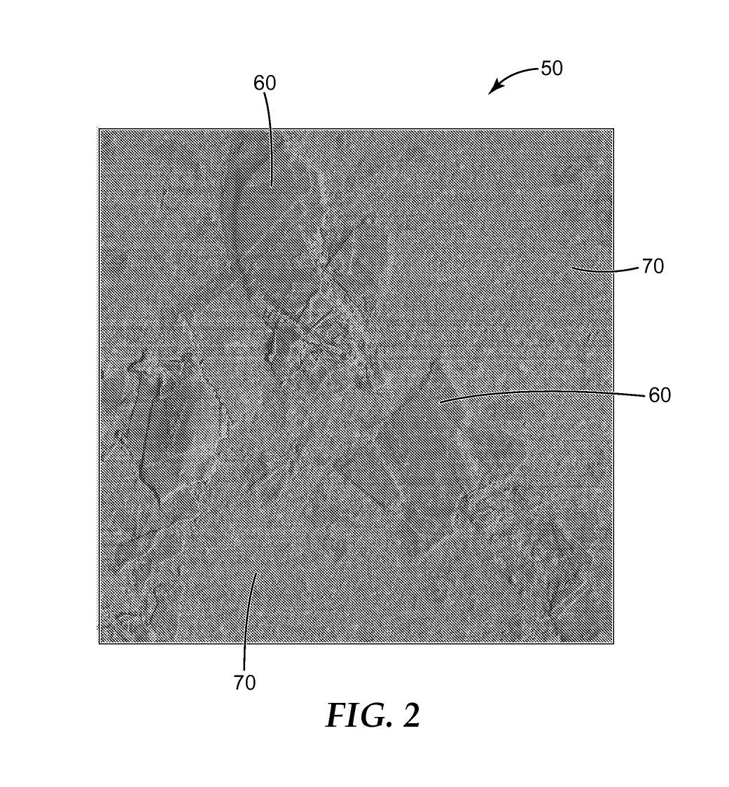

In various embodiments, as a result of the application methods disclosed herein, the carbon layer may have a characteristic morphology that is distinct from single layer graphene on the one hand, and from nano-crystalline carbon on the other hand. FIG. 2 is a scanning tunneling microscope (STM) image 50 of a carbon layer in accordance with some embodiments of the present disclosure. The scale of the image is such that the length of each side of the square-shaped image is 6 micrometers. The image reveals a morphology in which graphite platelets 60 are embedded in nano-crystalline carbon 70.

In some embodiments, the carbon layer may be formed on or over the contact surfaces at an average thickness of less than 500 microns, less than 100 microns, less than 3 microns, less than 1000 nanometers, less than 200 nanometers, or even less than 50 nanometers. In some embodiments, the carbon layer may be formed on or over the contact surfaces at an average thickness in a range of from 25 nanometers to 3 microns, from 50 nanometers to 1000 nanometers, or from 100 nanometers to 500 nanometers. In various embodiments, the carbon layer may be a carbon nanolayer which is formed on the substrate at an average thickness of less than 1000 nanometers, less than 200 nanometers, less than 50 nanometers, less than 10 nanometers, or even less than 1 nanometer. In illustrative embodiments, the carbon layer may have a uniform thickness. For purposes of the present disclosure, “uniform thickness” means having a relatively consistent thickness of coating over the desired dimension of the article in the plane of the substrate. The uniformity of the layer may be evaluated, for example, by optical evaluation using an optical densitometer. To evaluate uniformity, a transmission reading (or, alternatively, reflectance) may be taken at six points and compared to determine the variation. In some embodiments, the variation in thickness of the carbon layer is no more than 10%, no more than 5%, or no more than 3%.

In various embodiments, the carbon layer of the present disclosure may be deposited as described in U.S. Pat. No. 6,511,701.

In various embodiments, the electrical connector devices of the present disclosure may include one or more additional layers or materials (in addition to the carbon layer) formed on one or more of the contact surfaces. For example, other layers or coatings may include reactive coatings such as benzotriazoles, silanes, polymer coatings, monolayers, and/or metal plating.

In illustrative embodiments, the carbon layers of the present disclosure, which may be disposed on surfaces of the electrically conducting contacts, may exhibit properties that render the carbon layers particularly suitable for use as coatings for electrically conducting contacts. For example, the carbon layers may maintain strong electrical conductivity of the connectors of the electrically conducting contacts, while providing durable protection from corrosion. In this regard, in the mated position, the electrically conducting contacts of the present disclosure may have low resistance, and may maintain the low resistance even after multiple mating cycles (i.e., a sequence of mating and unmating the electrically conducting contacts) and multiple temperature-humidity cycles. In the mated position, the electrically conducting contacts of the present disclosure may exhibit a resistance of no more than 40 milliohms, no more than 30 milliohms, or even no more than 20 milliohms. Additionally, surprisingly, it was discovered that the carbon layers provide anti-corrosive properties and substantially prevent oxidation of the underlying electrically conducting contact surfaces. For example, after being subjected to heat and humidity aging, the electrically conducting contacts may have no more than a trace of copper oxide present at the conducting contact-carbon layer interface (or interphase region). Still further, it was discovered that the carbon layers are durable to abrasion (i.e., the carbon layers maintain their physical integrity after repeated mating cycles). For example, after being subjected to heat and humidity aging and 25 mating cycles (which far exceeds the typical product lifetime of ˜5-15 mating cycles), the composition of the carbon layer at the conducting contact-carbon layer interface (or interphase region) is substantially unchanged. Moreover, after 25 mating cycles, the thickness of the carbon layer may be at least 50% of the initial thickness of the carbon layer.

In further embodiments, the present disclosure relates to an elongated flexible conductor (e.g., wire) having an exterior surface. The exterior surface may bear thereon a carbon layer, as described above. The elongated flexible conductor may be formed, entirely or in part, from an electrically conducting material. For example, the electrically conducting material may include a metal, polymer, or other known conducting material. Suitable metals include, for example, copper, aluminum, nickel, platinum, tin, indium, combinations thereof, or alloys thereof. The elongated flexible conductor may have a length at least 5 times, at least 10 times, or even at least 100 times that of its cross section.

The present disclosure further relates to methods for forming the above-discussed electrical connector devices (or elongated flexible conductors) bearing thereon at least one carbon layer. Referring again to FIGS. 1A-1B, the methods may include depositing a carbon layer on or over a portion (up to the entirety) of the contact surfaces 20a and/or the contact surfaces 30a. The carbon layer may be formed on the contact surfaces 20a, 30a directly (i.e., onto a bare, uncoated surface) or indirectly (i.e., onto one or more coatings disposed on the contact surfaces 20a, 30a).

In some embodiments, depositing the carbon layer may include buffing an amount of an exfoliatable carbon material (and any additional components of the carbon layer such as a binder) onto the contact surfaces 20a, 30a. Alternatively, the carbon layer may be buffed onto an electrical connector precursor (i.e., a material blank that is to be later formed (e.g., pressed, molded) into an electrical connector). As used herein, “buffing” refers to any operation in which a pressure normal to a subject surface coupled with movement (e.g., rotational, lateral, combinations thereof) in a plane parallel to said subject surface is applied. In illustrative embodiments, the exfoliatable material may be applied as a dry composition that includes particles and optionally additional components such as polymeric microspheres and/or other microspheres. Thus, the composition to be applied is provided in a solid particulate form, rather than in a liquid or paste form. Exemplary carbons include conductive carbons such as graphite, carbon black, lamp black, or other conductive carbon materials. An example of useful exfoliatable carbon particles is HSAG300 graphite particles, available from Timcal Graphite and Carbon, Bodio, Switzerland. Other useful materials include but are not limited to SUPER P and ENSACO (Timcal), and M850 available from Asbury Carbon, Asbury, N.J. The carbon particles can also be or comprise carbon nanotubes, including multi-walled carbon nanotubes. The carbon particles may have a Mohs' hardness between 0.4 and 3.0 and a largest dimension of less than about 100 microns.

Buffing of the carbon layer may be carried out using any buffing apparatus known in the art suitable for applying dry particles to a surface (e.g., power sander, power buffer, orbital sander, random orbital sander), or manually (i.e., by hand). An exemplary buffing apparatus may include a motorized buffing applicator (e.g., disc, wheel) which may be configured to apply a pressure normal to a subject surface as well as rotate in a plane parallel to said subject surface. The buffing applicator may include a buffing surface that contacts with, or is intended to contact with, the subject surface during a buffing operation. In some embodiments, the buffing surface may include metal, polymer, glass, foam (e.g., closed-cell foam), cloth, paper, rubber, or combinations thereof. In various embodiments, the buffing surface may include an applicator pad that may be made of any appropriate material for applying particles to a surface. The applicator pad may, for example, be made of woven or non-woven fabric or cellulosic material. The applicator pad may alternatively be made of a closed cell or open cell foam material. In other cases, the applicator pad may be made of brushes or an array of nylon or polyurethane bristles. Whether the applicator pad comprises bristles, fabric, foam, and/or other structures, it may have a topography wherein particles of the composition to be applied can become lodged in and carried by the applicator pad.

In some embodiments, the buffing applicator may be configured to move in a pattern parallel to the subject surface and to rotate about a rotational axis perpendicular to the subject surface. The pattern may include a simple orbital motion or random orbital motion. Rotation of the buffing applicator may be carried out as high as 100 orbits per minute, as high as 1,000 orbits per minute, or even as high as 10,000 orbits per minute. The buffing applicator may be applied in a direction normal to the subject surface at a pressure of a least 0.1 g/cm², at least 1 g/cm², at least 10 g/cm², at least 20 g/cm², or even at least 30 g/cm².

The carbon layer can be formed on or over the contact surfaces 20a, 30a (or electrical connector precursor) in a number of ways. In one approach, the composition used to form the carbon layer can first be applied directly to the surfaces 20a, 30a, and then the buffing applicator may contact the composition and the surfaces 20a, 30a. In another approach, the composition can first be applied to the buffing surface of the buffing apparatus, and the particle-loaded buffing surface may then contact the surfaces 20a, 30a. In still another approach, a portion of the composition can be applied directly to the surfaces 20a, 30a and another portion of the composition can be applied to the buffing surface of the buffing apparatus, after which the particle-loaded buffing surface may contact the surfaces 20a, 30a and remainder of the composition.

In some embodiments, the buffing operation of the present disclosure can be used to produce a high quality, thin layer (e.g., a carbon nanolayer) on or over the surfaces 20a, 30a. The thickness of the buffed layer may be controlled by controlling the buffing time. Generally, the thickness of the coating may increase linearly with buffing time after a certain rapid initial increase. The coating thickness of the carbon layer may also be controlled by controlling the amount of the composition used during the buffing operation.

The buffing described herein may be used to produce high quality, low cost layers that are uniform in thickness, corrosion resistant, and of adequate electrical conductivity. Additionally, the buffing process of the present disclosure may accommodate formation of a carbon layer on all exposed portions of the contact surfaces 20a, 30a.

In illustrative embodiments, adherence of the carbon layer to the substrate may be assisted by heating the contact surfaces 20a, 30a prior to, during, or after the buffing operation to a temperature such that the adhesion of the layer is enhanced. Exemplary methods of heat input to the surfaces may include oven heating, heat lamp heating (e.g., infrared), or a heated platen in contact with the substrate.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### EXAMPLES

### Materials

Unless otherwise noted, all parts, percentages, ratios, etc., in the examples and in the remainder of the specification are by weight. Unless otherwise noted, all chemicals were obtained or are available from, chemical suppliers such as Aldrich Chemical Company, Milwaukee, Wis.

| Designation | Description | Supplier |
|---|---|---|
| KYNAR 761 | Polyvinylidene difluoride | Arkema Inc., King of |
| | (PVDF) | Prussia, PA |
| HSAG 300 | Graphite powder, | Timcal Ltd., Westlake, OH |
| | 6 micrometer average | |
| | particle size, | |
| XGnP-M-25 | Graphite powder with nano | XGSciences, Lansing, MI |
| | platelets, 25 micrometer | |
| | average particle size | |

### Methods

### Method for Determining Resistance of Coatings

The resistance of the connector devices prepared according to the examples and comparative examples described below were measured using a micro-ohm meter (Keithley Model 580, obtained from Keithley Instruments, Inc., Cleveland, Ohio). For the resistance measurements, the example and comparative example contacts were mated with gold-coated contacts and the resistance across the connector device was measured. The resistance measurement was repeated after the samples were subjected to a desired number of mating cycles (typically after 1, 5, and 25 mating cycles) to assess their quality and durability.

### Method for Thermal Shock Treatment

The samples prepared according to the examples described below were subjected to thermal shock treatment by exposure to five consecutive cycles of temperature extremes ranging from −55° C. to 105° C. The treatment was accomplished by first cooling the samples to −55° C. and holding at temperature for 30 minutes followed by rapidly heating to 105° C. with a hold at temperature for 30 minutes. The samples were then again cooled to −55° C. (with a 30 minute hold) to complete one cycle. The transition time between the temperature extremes was less than 60 seconds. The treatment was repeated for a total of five cycles.

### Method for Temperature-Humidity Cycling

The samples prepared according to the examples described below (after they were thermal shock treated) were subjected to temperature-humidity cycling by exposing them to 10 consecutive cycles of temperature-humidity stages. Each cycle lasted 24 hours for a total temperature-humidity cycling treatment of 10 days. For each 24-hour cycle, the samples were cycled through three temperature-humidity stages: i) 25° C. at 95% relative humidity, ii) 65° C. at 95% relative humidity, and iii) −10° C. at uncontrolled humidity. The samples were subjected to a given temperature-humidity stage once during a 24-hour cycle.

### Method for ESCA Analysis

The ESCA analysis of the samples prepared according to the examples described below was accomplished using a PHI VersaProbe 5000 ESCA (obtained from Physical Electronics, Inc., Chanhassen, Minn.) system which utilizes a monochromatic AlK-alpha x-ray excitation source and a hemispherical electron energy analyzer operated in a constant pass energy mode. The photoelectron collection (take-off) angle was 45° measured with respect to the sample surface with a +/−20° solid angle of acceptance.

In one embodiment of the ESCA analysis, the surface of the samples was etched using Ar⁺ (2 KeV, 2 A beam current and 2 millimeters×2 millimeters raster area) for a desired length of time and then performing ESCA analysis on the etched surface and then repeating the process again. Etching conditions were selected to obtain a desired etch rate. In this manner, ESCA analysis of the surface of the samples versus the etch time in seconds, which correlated to the ESCA analysis through the depth (i.e., thickness) of the sample, was obtained. In this mode, the ESCA analysis was useful to determine the compositional variation along the thickness of coatings and determining the thickness of the coatings.

### Example 1

### (EX1) and Comparative Example A (CEA)

CEA samples were insulation displacement connectors (IDC) having contacts made of gold-coated, copper-alloy blades.

To prepare EX1 samples, copper-alloy blades of IDC contacts (contacts commonly found in industry) were buff coated for 30 seconds with a 50:50 (by weight) buffing mixture of KYNAR 761:HSAG300 powders. The buffing was accomplished using a mechanical buffing device (model BO4900V Finishing Sander, marketed by Makita, Inc., La Mirada, Calif.) fitted with a nylon bristle pad (EZ PAINTR from Shur-Line, Huntesville, N.C.) to lightly buff the dry buffing mixture against the surface of contacts. The applicator pad of the buffing device moved in a rapid orbital motion about a rotational axis and was pressed lightly (i.e., less than about 30 g/cm²) against the surface of contacts. The buffed connector blades were then heated at 220° C. for 15 minutes.

Some of the EX1 and CEA samples were subjected to the thermal shock treatment and temperature-humidity cycling as described above.

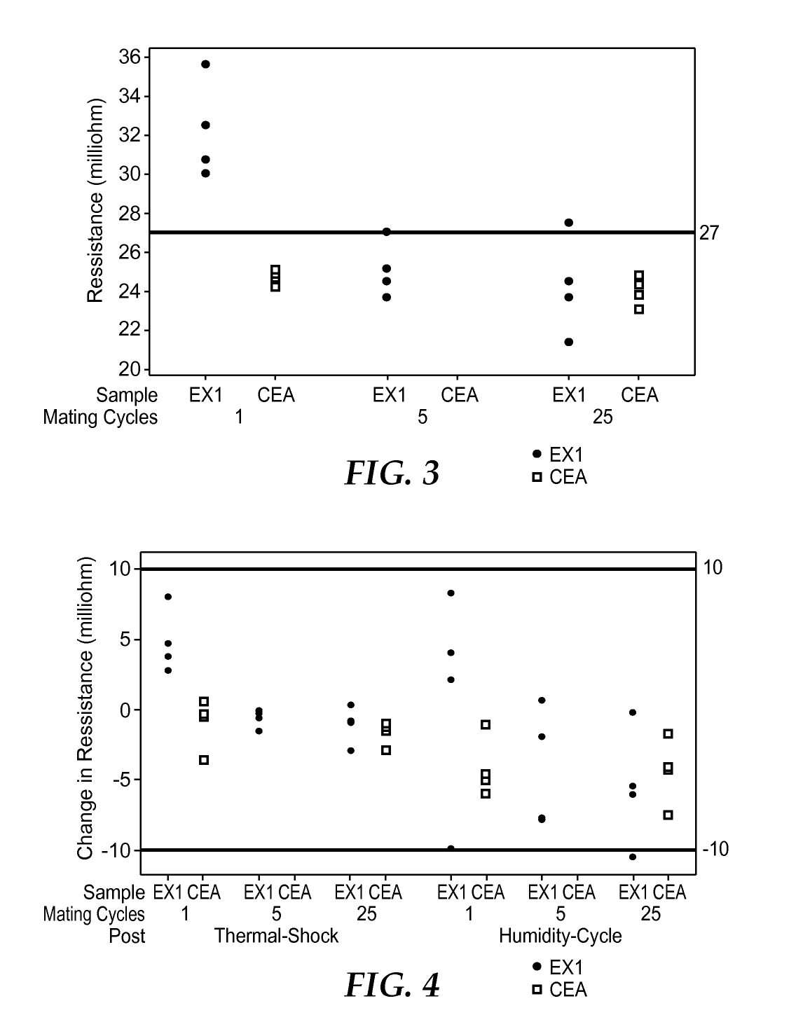

The resistance of the EX1 and CEA samples was then tested after they were mated with gold-coated contacts using the method described above. FIG. 3 summarizes the resistance data for as prepared EX1 and CEA samples after 1, 5, and 25 mating cycles with gold-coated contacts. FIG. 4 summarizes the resistance data for EX1 and CEA samples after thermal shock treatment and temperature-humidity cycling after 1, 5, and 25 mating cycles with gold-coated contacts.

### Examples 2-6

### EX2-EX6

EX2-EX6 were prepared in the same manner as EX1, except that the composition of buffing mixture was varied. For EX2, the buffing mixture was a 50:50 (by weight) mixture of KYNAR 761: XGnP-M-25 powders. For EX3, the buffing mixture was a 50:50 (by weight) mixture of KYNAR 761: HSAG300 powders. For EX4, the buffing mixture was a 25:75 (by weight) mixture of KYNAR 761: HSAG300 powders. For EX5, the buffing mixture was HSAG300 powder (i.e., no KYNAR 761 was added). For EX6, the buffing mixture was XGnP-M-25 powder (i.e., no KYNAR 761 was added).

Some of the EX2-EX6 samples were subjected to the temperature-humidity cycling as described above.

The resistance of the EX2-EX6 samples was then tested after they were mated with gold-coated contacts using the method described above.

Table 1 summarizes the resistance data for as prepared, thermal shock treated, and temperature-humidity cycled EX2-EX6 samples after 1, 5, and 25 mating cycles with gold-coated contacts.

TABLE 1

| | Resistance (milliohms) | | | Resistance (milliohms) | | | Resistance (milliohms) | | |
|---|---|---|---|---|---|---|---|---|---|
| | after 1 mating cycle | | | after 5 mating cycles | | | after 25 mating cycles | | |
| | | | Tempera- | | | Tempera- | | | Temper- |
| | | Thermal | ture- | | Thermal | ture- | | Thermal | ature- |
| | As | shock | humidity | As | shock | humidity | As | shock | humidity |
| Example | Prepared | treated | cycled | Prepared | treated | cycled | Prepared | treated | cycled |
| EX2 | 22.3 | 26.47 | Not measured | 28.63 | 29.10 | Not measured | 20.52 | 21.67 | Not measured |
| EX2 | 29.55 | 26.65 | Not measured | 27.13 | 28.61 | Not measured | 33.17 | 28.87 | Not measured |
| EX2 | 23.28 | 33.47 | Not measured | 23.42 | 32.56 | Not measured | 20.24 | 27.44 | Not measured |
| EX3 | 21.22 | 24.49 | Not measured | 24.43 | 32.07 | Not measured | 24.2 | 35.19 | Not measured |
| EX3 | 30.66 | 32.47 | Not measured | 24.42 | 34.27 | Not measured | 38.54 | 24.50 | Not measured |
| EX3 | 22.65 | 25.08 | Not measured | 23.34 | 33.84 | Not measured | 26.52 | 25.93 | Not measured |
| EX4 | 26.10 | 24.87 | Not measured | 23.86 | 26.35 | Not measured | 18.06 | 22 42 | Not measured |
| EX4 | 29.05 | 26.72 | Not measured | 19.97 | 27.40 | Not measured | 22.02 | 26.05 | Not measured |
| EX4 | 25.23 | 27.48 | Not measured | 21.29 | 28.85 | Not measured | 22.37 | 36.75 | Not measured |
| EX5 | 27.26 | Not measured | 20.03 | 25.32 | Not measured | 28.44 | 16.34 | Not measured | 16.52 |
| EX5 | 23.44 | Not measured | 23.82 | 24.37 | Not measured | 14.41 | 17.76 | Not measured | 14.12 |
| EX5 | 26.23 | Not measured | 29.45 | 22.43 | Not measured | 31.75 | 18.98 | Not measured | 14.64 |
| EX6 | 21.15 | Not measured | 19.96 | 20.01 | Not measured | 24.08 | 26.56 | Not measured | 17.25 |
| EX6 | 17.47 | Not measured | 22.23 | 19.73 | Not measured | 21.85 | 16.87 | Not measured | 15.02 |
| EX6 | 17.63 | Not measured | 30.05 | 19.14 | Not measured | 18.45 | 20.22 | Not measured | 14.89 |

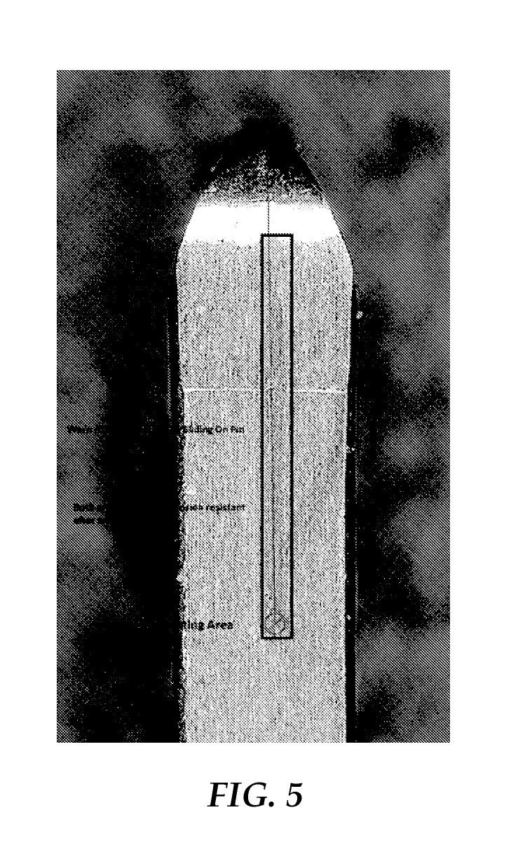

FIG. 5 is a photomicrograph of an EX3 sample after 25 mating cycles with a gold-coated contact. The “worn” area was where the EX3 sample made contact with the mating/corresponding gold-coated contact while the rest of the sample remained in “as prepared” state.

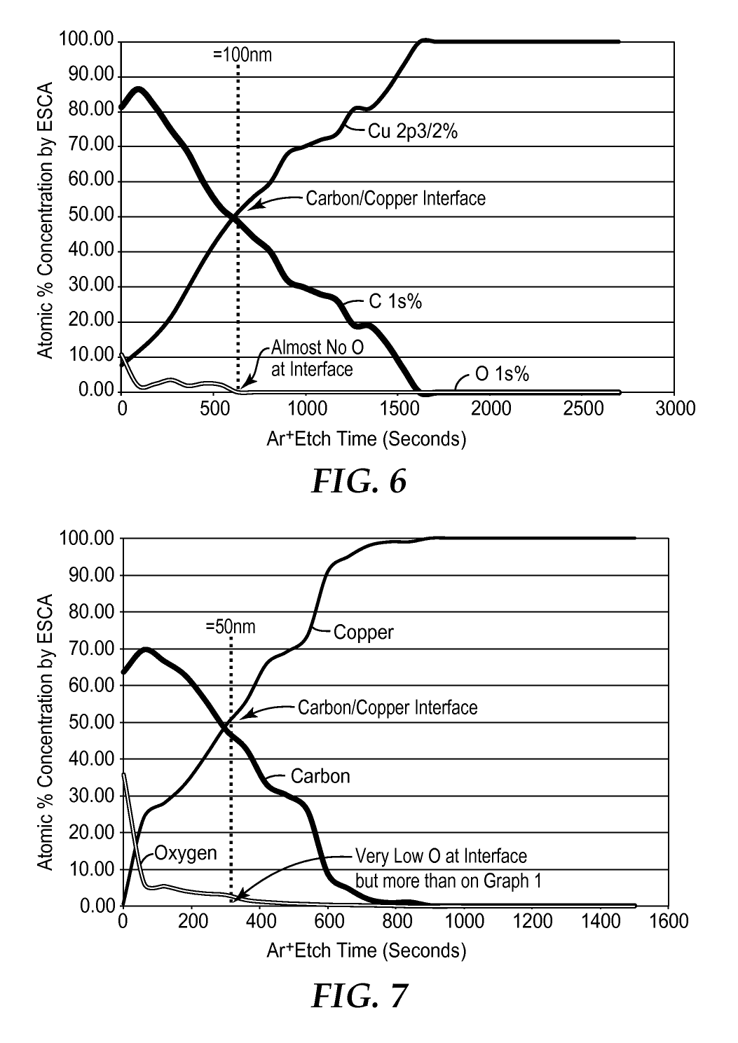

FIG. 6 is ESCA data for an “as prepared” area of an EX3 sample shown in FIG. 5, while FIG. 7 is ESCA data for a “worn” area of the same EX3 sample shown in FIG. 5. The thickness of the coating in the “as prepared” areas was estimated to be about 100 nanometers while the thickness of the coating was estimated to be 50 nanometers in the “worn” area of the coatings from the ESCA data. This observation was taken to be an indicator of the durability of carbon coated connectors prepared according to the present disclosure. In addition, the ESCA data for both “as prepared” and “worn” areas of EX3 sample had very low levels of O at the carbon-copper interface (or interphase region) which indicated the improved oxidation resistance of EX3 sample.

While not shown in FIG. 6 and FIG. 7, ESCA analysis of EX2-EX4 samples indicated presence of minor amounts of fluorine from binder (i.e., KYNAR 761) to be present in the carbon coatings.

Other embodiments of the invention are within the scope of the appended claims.

1. An electrical connector comprising:
a contact for making electrical connection with a corresponding contact of a mating connector, the contact comprising a contact surface; and
a carbon layer disposed on the contact surface;
wherein the carbon layer has a morphology comprising graphite platelets embedded in nano-crystalline carbon;
wherein an intermediate layer is disposed between the carbon layer and the contact surface, and wherein the intermediate layer comprises a polymer layer or a mono layer.

2. The electrical connector of claim 1, wherein the carbon layer has an average thickness of less than 1000 nanometers.

3. The electrical connector of claim 1, wherein the carbon layer has an average thickness of less than 100 nanometers.

4. The electrical connector of claim 1, wherein the carbon layer has a uniform thickness.

5. The electrical connector of claim 1, wherein the carbon layer is disposed directly on the contact surface.

6. The electrical connector of claim 1, wherein the carbon layer comprises a conductive carbon material.

7. The electrical connector of claim 1, wherein the carbon layer comprises a polymeric binder.

8. The electrical connector of claim L, wherein the contact comprises a metal.

9. The electrical connector of claim 8, wherein the metal comprises copper, a copper alloy, or combinations thereof.

10. The electrical connector of claim 1, wherein an intermediate layer is disposed between the carbon layer and the contact surface.

11. A method of making an electrical connector, the method comprising:
providing a contact for making electrical connection with a corresponding contact of a mating connector, the contact comprising a contact surface;
applying a dry composition comprising a carbon material on or over the contact surface.

12. The method of claim 11, wherein applying the dry composition comprises buffing the dry composition on or over the contact surface to form a carbon layer.

13. (canceled)

14. The method of claim 12, wherein following buffing of the dry composition, the carbon layer has a morphology comprising graphite platelets embedded in nano-crystalline carbon.

15. The method of claim 11, wherein the carbon material comprises a conductive carbon material.

16. The method of claim 11, wherein the dry composition comprises a polymeric binder.

17. The method of claim 11, wherein the carbon layer has an average thickness of less than 100 nanometers.

18. The method of claim 11, wherein the carbon layer has a uniform thickness.

19-20. (canceled)

21. An electrical connector comprising:
an insulative housing;
a plurality of contacts for making electrical connection with corresponding contacts of a mating connector, wherein the contacts comprise a contact surface and wherein the contacts are at least partially disposed within the insulative housing;
a carbon layer disposed on the contact surfaces;
wherein the carbon layer has a morphology comprising graphite platelets embedded in nano-crystalline carbon; and
wherein an intermediate layer is disposed between the carbon layer and the contact surface, and wherein the intermediate layer comprises a polymer layer or a mono layer.
